(19) United States
(12) Patent Application Publication
(10) Pub. No.: US 2009/0290834 A1
(43) Pub. Date: Nov. 26, 2009

(54) Optical Switch

(75) Inventors: Yuichi Niimura, Osaka-shi (JP); Mitsuo Ichiya, Suita-shi (JP); Tsutomu Shimomura, Toyonaka-shi (JP); Sachiko Kimura, Settsu-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: MATSUSHITA ELECTRIC WORKS, LTD., Kodama-shi (JP)

(21) Appl. No.: 11/795,759

(22) PCT Filed: Jan. 24, 2005
(86) PCT No.: PCT/JP05/00854

§ 371 Date: Jul. 20, 2007

(51) Int. Cl. G02B 6/26

(52) U.S. Cl. 385/18

(57) ABSTRACT

An optical switch is provided, which is used to switch a light path(s) between at least three lenses spaced from each other in a horizontal direction, or in horizontal and vertical directions. This optical switch comprises a lens supporting member for supporting the lenses, fixed prism optically coupled to the lenses, and a movable prism supported to be movable relative to the lens supporting member. The movable prism is driven by an actuator between a first position where a light path is formed between two of the lenses by use of the fixed prism and a second position where a light path is formed between another two of the lenses by use of the movable prism.

### TECHNICAL FIELD

The present invention relates to an optical switch, which is preferably used to switch a light path in an optical communication system, or a laser-beam path in laser machining.

### BACKGROUND ART

In a recent dramatic development in optical transmission technique, an optical switch for switching a transmission path for light signal or light energy plays an important role. For example, Japanese Patent Early Publication [kokai] No. 2003-15059 discloses an optical switch using a movable prism. As shown in FIGS. 19A and 19B, this optical switch is used to switch light paths by allowing a prism 6M to move in and out between ends of a pair of input optical fibers (2a, 2c) and ends of a pair of output optical fibers (2b, 2d). In this case, since a straight movement of the prism 6M reduces a dead space in the device, the optical switch can be downsized as a whole.

This optical switch is effective when the input optical fibers (2a, 2c) are respectively disposed on the same axes as the output optical fibers (2b, 2d). However, when the input optical fibers and the output optical fibers are disposed in parallel, it is needed to adopt another switching mechanism.

On the other hand, Japanese Patent Early Publication [kokai] No. 2004-37652 discloses an optical switch for switching light paths when input optical fibers (2a, 2c) and output optical fibers (2b, 2d) are disposed in substantially parallel to each other on the same plane, as shown in FIG. 20. A mirror block 6N used in this optical switch has a complex shape with reflecting portions for providing the light paths shown in FIG. 21A, and reflecting portions for providing the light paths shown in FIG. 21B. The light paths can be switched by moving the mirror block 6N relative to the optical fibers in directions shown by the arrows in FIG. 20.

However, since those reflecting portions are integrally formed, it is needed to manufacture the complex geometrical shape of the mirror block 6N with a high degree of accuracy. In addition, when positioning one of the reflecting portions, it affects on positions of all of the reflecting portions of the mirror block 6N. Therefore, it is difficult to individually adjust the positions of the reflecting portions after assembling of the device. Furthermore, due to the use of the mirror block manufactured with such a high degree of accuracy, the optical switch still has plenty of room for improvement in view of cost performance.

### SUMMARY OF THE INVENTION

Therefore, a primary concern of the present invention is to provide a new optical switch with a switching mechanism using a fixed light-guiding member and a movable light-guiding member, which is different from the above-described conventional cases.

That is, the optical switch of the present invention comprises at least three lenses, lens supporting member configured to support the lenses, fixed light-guiding member optically coupled to the lenses, and a movable light-guiding member, and is characterized in that the movable light-guiding member is movable relative to the lenses between a first position where a light path is formed between two lenses of the at least three lenses by use of the fixed light-guiding member and a second position where a light path is formed between another two lenses of the at least three lenses by use of the movable light-guiding member.

According to the present invention, since the light path are switched by selecting one of the reflection of light by use of the movable light-guiding member and the reflection of light by use of the fixed light-guiding member, the movable light-guiding member can be configured in a relatively simple shape. Consequently, it is possible to provide the optical switch with easiness of positioning optical parts, and improved cost performance. According to the technical concept of the present invention, as described later, it is also possible to provide a compact optical switch for switching between the light paths provided in two directions, i.e., horizontal and vertical directions in addition to the optical switch for switching between the light paths provided in the horizontal direction.

In the present optical switch, it is preferred that the fixed light-guiding member comprises a first reflecting portion for reflecting a light emitted from one of the two lenses in the first position, and a second reflecting portion for reflecting the light reflected by the first reflecting portion toward the other one of the two lenses. For example, it is preferred that the fixed light-guiding member is formed with a body made of a translucent material, and the first and second reflecting portions formed on a pair of surfaces of the body. Alternatively, it is preferred that the fixed light-guiding member is formed by a trapezoidal prism, and the first and second reflecting portions are provided by a pair of inclined surfaces of the trapezoidal prism, which are in an orthogonal relation to each other.

Similarly, it is preferred that the movable light-guiding member comprises a third reflecting portion for reflecting a light emitted from one of the another two lenses in the second position, and a fourth reflecting portion for reflecting the light reflected by the third reflecting portion toward the other one of the another two lenses. For example, it is preferred that the movable light-guiding member is formed with a body made of a translucent material, and the third and fourth reflecting portions formed on a pair of surfaces of the body.

In the optical switch of the present invention, it is also preferred the at least three lenses are composed of first, second, third and fourth lenses disposed such that their optical axes are parallel to each other, and light paths are formed between the first and second lenses and between the third and fourth lenses at the first position, and light paths are formed between the first and fourth lenses and between the second and third lenses at the second position. In particular, it is preferred that the first, second, third and fourth lenses are supported by the lens supporting member such that their optical axes are parallel to each other in horizontal and vertical directions. In this case, it is possible to switch the light paths between a plurality of light transmission members such as optical fibers arranged in matrix pattern.

As a preferred embodiment of the optical switch using the four lenses described above, the fixed light-guiding member has at least one pair of reflecting portions (e.g., “50” and “51” in FIG. 3A) for reflecting lights emitted from one of the first and second lenses and one of the third and fourth lenses, and reflecting a resultant pair of reflection lights respectively toward the other one of the first and second lenses and the other one of the third and fourth lenses at the first position. The movable light-guiding member has at least one pair of reflecting portions (e.g., two pairs of reflecting portions “(63, 65)” and “(64, 66”) in FIG. 4C) for reflecting lights emitted from one of the first and fourth lenses and one of the second and third lenses, and reflecting a resultant pair of reflection lights respectively toward the other one of the first and fourth lenses and the other one of the second and third lenses at the second position. In this case, it is particularly preferred that an angle between the at least one pair of reflecting portions of the fixed light-guiding member and an angle between the at least one pair of reflecting portions of the movable light-guiding member are right angles, respectively. In this embodiment, the fixed and movable light-guiding members each having a relatively simple structure can be used, as shown in FIG. 3. Consequently, it is possible to provide the optical switch having improved cost performance.

In the above optical switch, it is preferred that the movable light-guiding member is disposed such that an axis (“X” in FIG. 3A) extending in parallel with the at least one pair of reflecting portions of the fixed light-guiding member is orthogonal to the axis (“Y” in FIG. 4A) extending in parallel with the at least one pair of reflecting portions of the movable light-guiding member. According to this embodiment, the light path can be formed between the lenses spaced from each other in the vertical direction by use of the fixed light-guiding member at the first position. On the other hand, at the second position, the light path can be formed between the lenses spaced from each other in the horizontal direction by use of the movable light-guiding member. Therefore, this optical switch presents an improved degree of freedom of design of the light path.

As a particular preferred embodiment of the optical switch using the four lenses of the present invention, the fixed light-guiding member comprises a first reflecting portion (50) for reflecting a light emitted from the first lens, second reflecting portion (51) for reflecting a light emitted from the third lens, third reflecting portion (51) for reflecting the light reflected by the first reflecting portion toward the second lens, and a fourth reflecting portion (50) for reflecting the light reflected by the second reflecting portion toward the fourth lens at the first position. On the other hand, the movable light-guiding member comprises a fifth reflecting portion (63) for reflecting a light emitted from the first lens, sixth reflecting portion (65) for reflecting the light reflected by the fifth reflecting portion toward the fourth lens, seventh reflecting portion (66) spaced away from the sixth reflecting portion by a space (21) to reflect a light emitted from the third lens, and an eighth reflecting portion (64) spaced from the fifth reflecting portion by a space (20) to reflect the light reflected by seventh reflecting portion toward the second lens at the second position.

In the first position, the light path between the first and second lenses is formed through the space between the fifth and eighth reflecting portions (63, 64), and the light path between the third and fourth lenses is formed through the space between the sixth and seventh reflecting portions (65, 66). In this case, it is preferred that angles between the first reflecting portion (50) and the third reflecting portion (51), between the second reflecting portion (51) and the fourth reflecting portion (50), between the fifth reflecting portion (63) and the sixth reflecting portion (65), and between the seventh reflecting portion (66) and the eighth reflecting portion (64) are right angles, respectively. According to this embodiment, since the light paths are provided through the spaces formed in the movable light-guiding member, a travel distance of the movable light-guiding member relative to the lens supporting member can be reduced. As a result, it is possible to provide a compact optical switch for switching light paths between a plurality of light transmission members such as optical fibers arranged in a matrix pattern.

In addition, it is preferred that the fixed light-guiding member of the above optical switch comprises a single reflecting surface (50) providing the first reflecting portion and the fourth reflecting portion, and a single reflecting surface (51) providing the second reflecting portion and the third reflecting portion, and an angle between these reflecting surfaces is right angle. Furthermore, it is preferred that the movable light-guiding member of the above optical switch is composed of a pair of blocks (60, 62) each having two reflecting portions that are in an orthogonal relation to each other, and a coupling member (61) for coupling between the pair of blocks such that the reflecting portions of one of the blocks are spaced away from the reflecting portions of the other block by a space.

In the present invention, the concept of “reflection” comprises total reflection and reflection by mirror coating. In the case that a refractive index on a light path changes from high to low, the total reflection happens when the difference in refractive index (for example, the difference in refractive index between a translucent member and air) and the reflection angle satisfy a certain condition. The reflection by a prism is based on this phenomenon. In the case of the reflection by mirror coating, light can be reflected at an arbitrary surface with the mirror coating. In other words, even when the difference in refractive index between a translucent member and a reflection-side member and the reflection angle do not satisfy the total-reflection condition, it is possible to achieve the reflection by the mirror coating. Therefore, in this case, a non-translucent material can be also utilized.

Additional features and advantages brought thereby of the present invention will be understood in detail from preferred embodiments of the present invention described below with reference to the attached drawings.

### BRIEF EXPLANATION OF THE DRAWINGS

FIGS. 1A to 1C are a longitudinal sectional view, transverse sectional view and a front view of an optical switch according to a first embodiment of the present invention, respectively;

FIG. 2 is a perspective view of a lens supporting member integrally molded with lenses of the optical switch;

FIGS. 3A to 3C are a perspective view, side view and a front view of a fixed prism of the optical switch, respectively;

FIGS. 4A to 4C are a perspective view, top view and a front view of a movable prism of the optical switch, respectively;

FIGS. 5A and 5B are a perspective view and a conceptual diagram showing light paths formed at a first position of the movable prism;

FIGS. 6A and 6B are a perspective view and a conceptual diagram showing light paths formed at a second position of the movable prism;

FIGS. 7A and 7B are perspective views showing modifications of the fixed light-guiding member;

FIGS. 8A to 8D are perspective views showing modifications of the movable light-guiding member;

FIGS. 9A and 9B are perspective views showing modifications of the lens supporting member;

FIGS. 10A and 10B are a longitudinal sectional view and a transverse sectional view of an optical switch according to a second embodiment of the present invention;

FIGS. 11A and 11B are a perspective view and a cross-sectional view of a lens supporting member used in this embodiment;

FIGS. 12A and 12B are a perspective view and a top view of a fixed prism of the optical switch;

FIGS. 13A and 13B are a perspective view and a top view of a movable prism of the optical switch;

FIGS. 14A and 14B are a perspective view and a conceptual diagram showing light paths formed at the first position of the movable prism;

FIGS. 15A and 15B are a perspective view and a conceptual diagram showing light paths formed at the second position of the movable prism;

FIGS. 16A to 16C are perspective views showing modifications of the fixed light-guiding member;

FIGS. 17A and 17B are perspective views showing modifications of the movable light-guiding member;

FIG. 18 is a perspective view showing a modification of the lens supporting member;

FIGS. 19A and 19B are explanatory views showing a light-path switching mechanism of a conventional optical switch;

FIG. 20 is a perspective view of a mirror block of another conventional optical switch; and

FIGS. 21A and 21B are explanatory views showing a light-path switching mechanism of the optical switch of FIG. 20.

### BEST MODE FOR CARRYING OUT THE INVENTION

An optical switch of the present invention is explained in detail according to preferred embodiments, referring to the attached drawings.

### First Embodiment

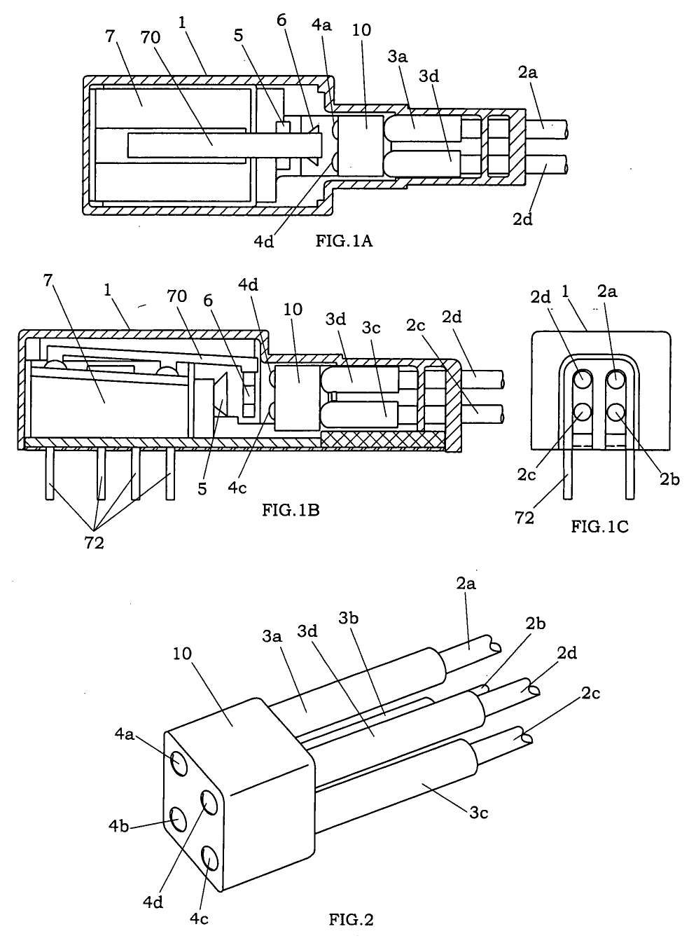

As shown in FIGS. 1A to 1C and 2, the optical switch of this embodiment comprises a housing 1 made of a synthetic resin and having openings at its one end, through which a plurality of optical fibers (in this embodiment, four optical fibers 2a, 2b, 2c, 2d) can be introduced into the housing, four collimating lens (4a, 4b, 4c, 4d), each of which is connected to the optical fiber through a ferrule (3a, 3b, 3c, 3d), lens supporting member 10 for supporting these lenses, fixed light-guiding member 5 optically coupled to the lenses, movable light-guiding member 6 supported to be movable relative to the lens supporting member 10, and an actuator 7 that is an electromagnetic device for moving the movable light-guiding member 6 between a first position where a light path is formed between adjacent optical fibers in a longitudinal direction by use of the fixed light-guiding member 5, and a second position where a light path is formed between adjacent optical fibers in a lateral direction by use of the movable light-guiding member.

In this embodiment, as shown in FIG. 1C, the optical fibers (2a to 2d) are arranged in a 2×2 matrix pattern such that their optical axes are parallel to each other in the longitudinal and lateral directions. In addition, as shown in FIG. 2, the four lenses (4a to 4d) and the lens supporting member 10 are formed by integral molding such that these lenses are filled in the lens supporting member 10 having a cubic shape. This facilitates an assembling operation of the optical switch.

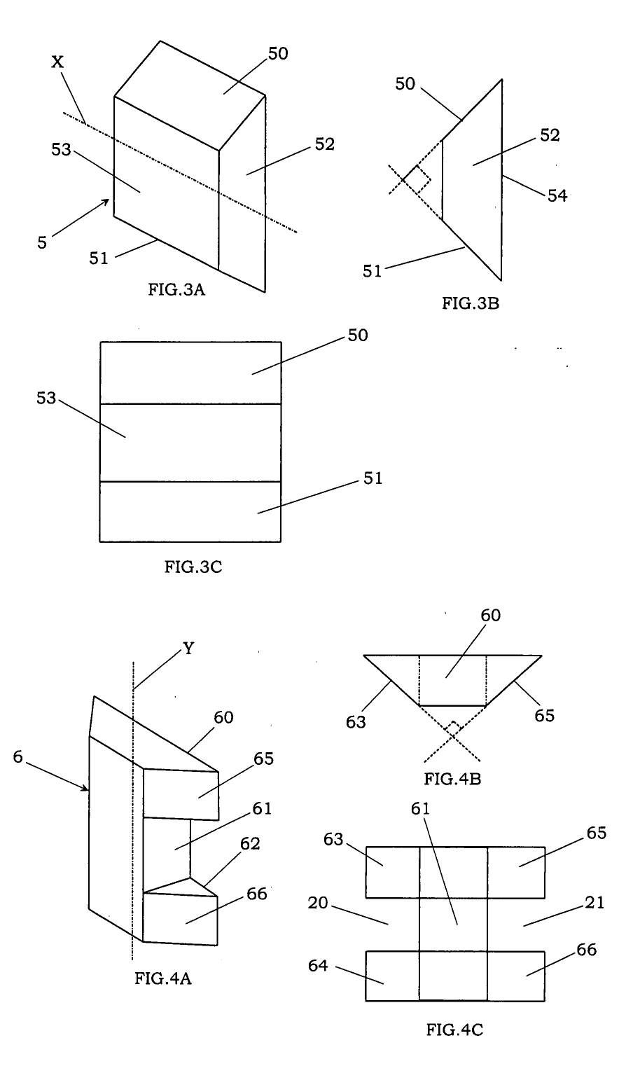

As the fixed light-guiding member 5 of this embodiment, as shown in FIGS. 3A to 3C, a fixed prism having a trapezoidal cross section is used. As described later, this fixed prism has a pair of reflecting portions (50, 51) for reflecting a light emitted from the lens 4a, and then reflecting a resultant reflected light toward the lens 4b, and simultaneously reflecting a light emitted from the lens 4c and then reflecting a resultant reflected light toward the lens 4d at the first position. Concretely, this fixed prism 5 is composed of a pair of trapezoidal faces 52, top face 53 having an upper base of the trapezoid as its one side, bottom face 54 having a lower base of the trapezoid as its one side, and a pair of inclined faces (50, 51) extending between the top and bottom faces. An angle between the inclined faces is right angle, as shown in FIG. 3B. Hereinafter, the inclined faces of the fixed prism 5 are referred to as reflecting surfaces (50, 51). The fixed prism 5 is disposed such that the bottom face 54 faces the lenses (4a to 4d) through a space for allowing the movable light-guiding member 6 to move in and out. In the drawings, “X” designates an axis of the fixed prism extending parallel to the pair of reflecting surfaces (50, 51).

As the movable light-guiding member 6 of this embodiment, as shown in FIGS. 4A to 4C, a movable prism is used, which has an integral structure comprised of a pair of trapezoidal prisms each having a similar shape to the fixed prism 5 and a coupling member 61 for coupling therebetween. As described later, this movable prism has a reflecting surface 63 for reflecting a light emitted from the lens 4a, reflecting surface 65 for reflecting the light reflected by the reflecting surface 63 toward the lens 4d, reflecting surface 66 spaced from the reflecting surface 65 through a space 21 to reflect a light emitted from the lens 4c, and a reflecting surface 64 spaced from the reflecting surface 63 through a space 20 to reflect the light reflected by the reflecting surface 66 toward the lens 4b at the second position. Concretely, the reflecting surfaces 63, 65 are provided by a pair of inclined surfaces of the upper trapezoid prism 60, and the reflecting surfaces 64, 66 are provided by a pair of inclined surfaces of the lower trapezoid prism 62. An angle between the reflecting surfaces 63, 65 and an angle between the reflecting surfaces 64, 66 are right angles. The movable prism 6 is disposed such that a bottom face including lower bases of the trapezoid prisms faces the lenses (4a to 4d). This movable prism can be relatively easily manufactured by removing center portions of a pair of inclined surfaces from a large trapezoid prism. In the drawings, “Y” designates an axis of the movable prism extending parallel to these reflecting surfaces.

The actuator 7 is not restricted on the assumption that the movable prism 6 can be moved upward and downward. In this embodiment, by moving an arm 70 with the movable prism secured to its one end, the movable prism 6 is allowed to move in and out of a space between the fixed prism 5 and the lenses (4a to 4d). To form the light paths between the lenses (4a and 4b, 4c and 4d) spaced from each other in the vertical direction by use of the fixed prism 5 at the first position, and form the light paths between the lenses (4a and 4d, 4b and 4c) spaced from each other in the horizontal direction by use of the movable prism 6 at the second position, the movable prism 6 is secured to the arm 70 such that the axis “X” of the fixed prism 5 is orthogonal to the axis “Y” of the movable prism 6. In the figure, the numeral 72 designates terminals used to supply electric current to a coil of the actuator. When the lens supporting member 10, fixed prism 5, and the actuator 7 are previously mounted on a substrate, and then the substrate is installed in the housing 1, it is possible to efficiently and easily assemble the optical switch.

Next, operations of the optical switch are explained. At the first position where the movable prism 6 secured to the one end of the arm 70 is moved upward from the space between the lenses (4a to 4d) and the fixed prism 5 by the actuator 7, the lenses (4a to 4d) are optically connected to the fixed prism 5. In this embodiment, as shown in FIGS. 5A and 5B, the light provided from the optical fiber 2a through the lens 4a is sent to the fixed prism 5 through the space 20 between the reflecting surfaces (63, 64) of the movable prism 6, and reflected by the reflecting surface 50 of the fixed prism 5. The light reflected by the reflecting surface 50 is then reflected toward the lens 4b by the reflecting surface 51 of the fixed prism 5. As a result, the light path is formed between these lenses 4a, 4b. Similarly, the light provided from the optical fiber 2c through the lens 4c is reflected by the reflecting surface 51 of the fixed prism 5. The light reflected by the reflecting surface 51 is then reflected toward the lens 4d by the reflecting surface 50 of the fixed prism 5 through the space 21 between the reflecting surfaces (65, 66) of the movable prism 6. As a result, the light path is formed between these lenses 4c, 4d. Thus, at the first position, the light paths are formed between the lenses (4a and 4b, 4c and 4d) spaced from each other in the vertical direction. In the embodiment, since the spaces 20, 21 are effectively used to form the light paths, it is possible to shorten a distance of the upward movement of the movable lens 6 and reduce the height size of the optical switch. In addition, the reflecting surface 50 of the fixed prism 5 is used in common for the reflection of the light provided from the lens 4a and the reflection of the light reflected by the reflecting surface 51 toward the lens 4d. Similarly, the reflecting surface 51 of the fixed prism 5 is used in common for the reflection of the light provided from the lens 4c and the reflection of the light reflected by the reflecting surface 50 toward the lens 4b.

As an alternative case of the first position, the light provided from the optical fiber 2a through the lens 4a is sent to the fixed prism 5 through the space 20 between the reflecting surfaces (63, 64), and reflected by the reflecting surface 50 of the fixed prism 5. The light reflected by the reflecting surface 50 is then reflected toward the lens 4b by the reflecting surface 51 of the fixed prism 5. On the other hand, the light provided from the optical fiber 2d through the lens 4d is sent to the fixed prism 5 through the space 21 between the reflecting surfaces (65, 66), and reflected by the reflecting surface 50 of the fixed prism 5. The light reflected by the reflecting surface 50 is then reflected toward the lens 4c by the reflecting surface 51 of the fixed prism 5.

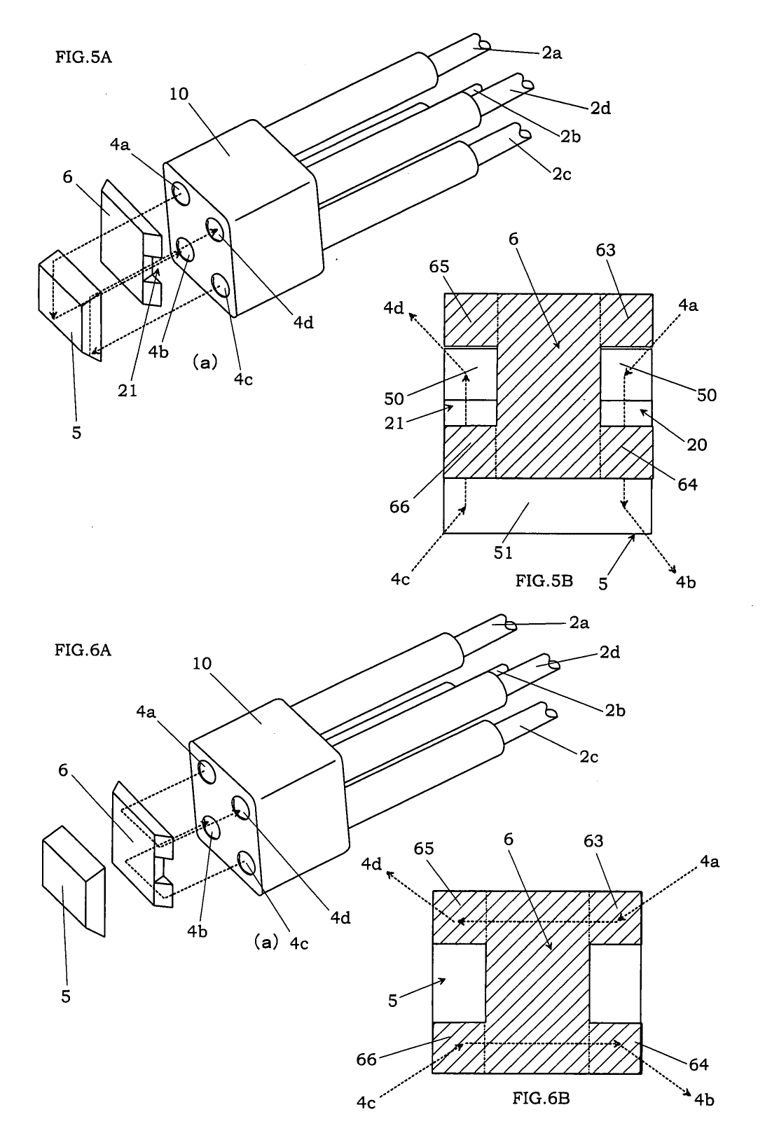

In the second position where the movable prism 6 is moved downward into the space between the lends (4a to 4d) and the fixed prism 5 by the actuator 7, the lenses (4a to 4d) are optically connected to the movable prism 6. In the embodiment, as shown in FIGS. 6A and 6B, the light provided from the optical fiber 2a through the lens 4a is reflected by the reflecting surface 63 of the movable prism 6. The light reflected by the reflecting surface 63 is reflected toward the lens 4d by the reflecting surface 65 of the movable prism 6. As a result, the light path is formed between the lenses (4a, 4d). Similarly, the light provided from the optical fiber 2c through the lens 4c is reflected by the reflecting surface 66 of the movable prism 6. The light reflected by the reflecting surface 66 is reflected toward the lens 4b by the reflecting surface 64 of the movable prism 6. As a result, the light path is formed between the lenses (4b, 4c). Thus, at the second position, the light paths are formed between the lenses (4a and 4d, 4b and 4c) spaced from each other in the horizontal direction.

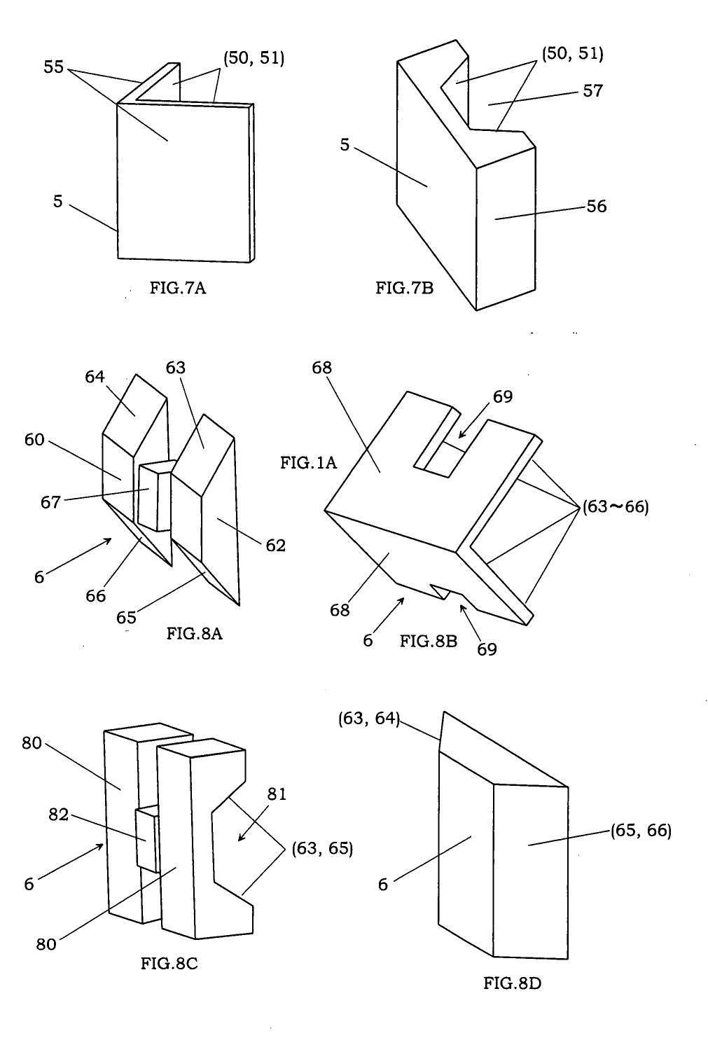

In the above embodiment, the prism having the trapezoid cross section was used to downsize the fixed prism. Alternatively, a prism having a cross section of a right-angled isosceles triangle may be used, which is characterized in that a pair of reflecting surfaces are orthogonal to each other to define a right-angle corner portion. In addition, as another preferred embodiments of the fixed light-guiding member 5 of the present optical switch, as shown in FIG. 7A, a thin L-shaped member may be used, which is formed with a pair of plates connected to each other such that an intersection angle therebetween is right angle, and a pair of reflecting surfaces (50, 51) formed as the reflecting portions on these plates by, for example, a mirror coating. In addition, as shown in FIG. 7B, a reflection coating member may be used, which comprises a rectangular solid body 56, concave 57 formed in this body, and a pair of reflecting surfaces (50, 51) obtained by performing a reflection coating such as the mirror coating on a pair of inclined surfaces in the concave 57.

The movable prism used in this embodiment is formed with the pair of trapezoid prisms (60, 62) and the coupling portion 61 extending therebetween and made of the same optical material as the trapezoid prisms. Alternatively, as shown in FIG. 8A, the movable prism may be composed by bonding a pair of trapezoid prisms (60, 62) and a coupling member 67 interposed therebetween and made of a material different from the material of these prisms. In this case, the size of the coupling member 67 is appropriately determined such that the spaces (20, 21) needed to form the light paths at the first position are provided between the trapezoid prisms (60, 62).

Alternatively, as another preferred embodiments of the movable light-guiding member 6 of the present optical switch, a thin L-shaped member shown in FIG. 8B may be used, which comprises a pair of plates 68 connected to each other such that an intersection angle therebetween is a right angle, a pair of notches 69 formed at predetermined positions of the plates and used to form the light paths in the first position, and reflecting surfaces (63 to 66) formed as the reflecting portions on the plates. In addition, a reflection coating member shown in FIG. 8C may be used, which comprises a pair of rectangular solid bodies 80, concave 81 formed in each of the bodies, and a pair of reflecting surfaces (63 and 65, 64 and b) obtained by performing a reflection coating (e.g., a mirror coating) on a pair of inclined surfaces in each of the concaves, and a coupling member 82 interposed between the bodies. Furthermore, a prism formed in a relatively simple shape shown in FIG. 8D may be used, which has a trapezoid cross section and reflecting surfaces (63 and 64, 65 and 66) provided by a pair of inclined surfaces. In this case, since the prism does not have the spaces (20, 21) used to form the light paths at the first position, the travel distance of the movable prism 6 moved by the actuator 7 increases. However, since the movable prism 6 has substantially the same shape as the fixed prism 5, it is possible to provide the optical switch with excellent cost performance.

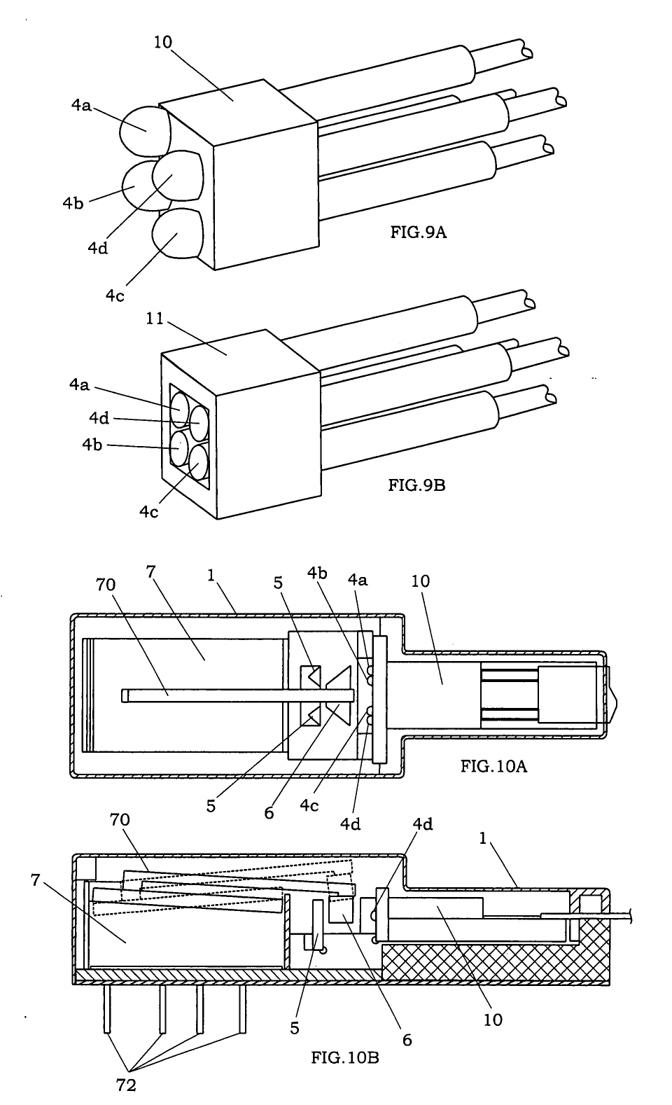

In place of the molded article of the lens supporting member 10 and the lenses used in this embodiment, it is possible to use a lens block formed by embedding hemispherical lenses or spherical lenses in the lens supporting member 10, as shown in FIG. 9A, or a lens block formed by installing separately molded lenses or GRIN lenses in a lens supporting member 11 having a rectangular tubular shape, as shown in FIG. 9B.

To enhance the understanding of the invention, the light-path switching mechanism in the matrix (2×2) arrangement of the four optical fibers was explained in this embodiment. However, the number of optical fibers used in the optical switch is not restricted to four. For example, sizes of the fixed prism and the movable prism, the number of prisms, or the number of reflecting surfaces formed on the prism can be increased depending on the number of optical fibers to be switched.

### Second Embodiment

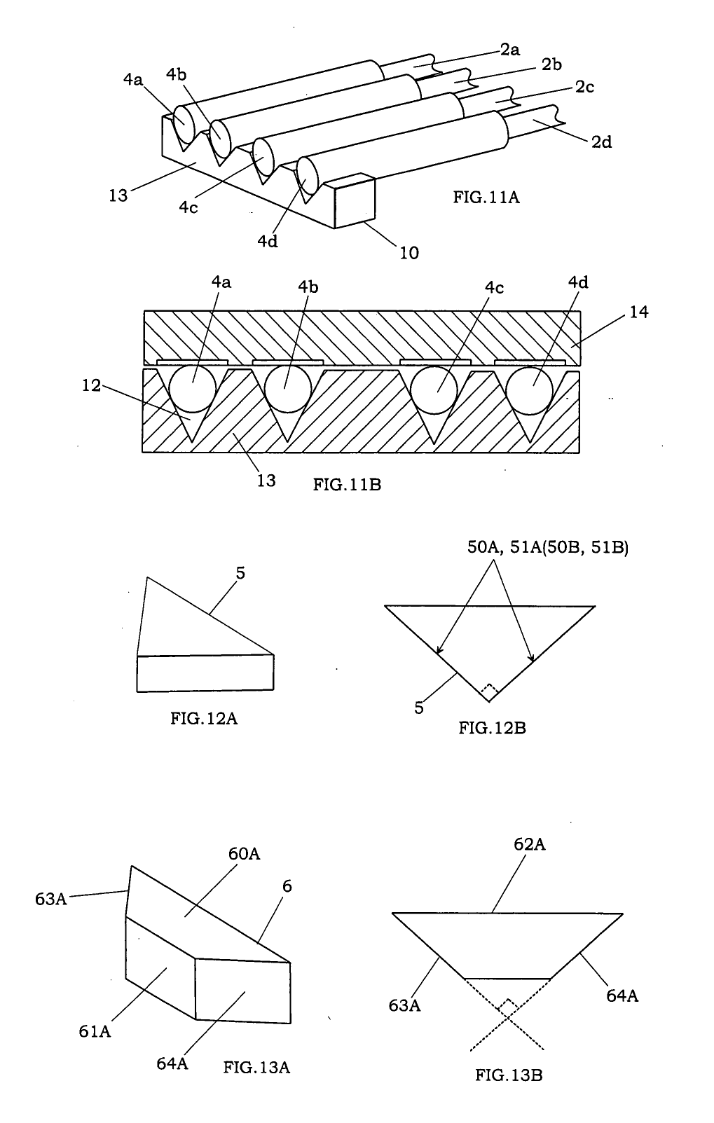

As shown in FIGS. 10A, 10B, 11A and 11B, an optical switch of the present embodiment comprises a housing 1 made of a synthetic resin and having an opening at its one end, through which a plurality of optical fibers (in this embodiment, four optical fibers 2a, 2b, 2c, 2d) can be introduced into the housing, four collimating lens (4a, 4b, 4c, 4d), each of which is connected to the optical fiber, lens supporting member 10 for supporting these lenses, fixed light-guiding member 5 optically coupled to the lenses, movable light-guiding member 6 supported to be movable relative to the lens supporting member, and an actuator 7 that is an electromagnetic device for moving the movable light-guiding member 6 between a first position where a light path is formed between a pair of the optical fibers in a lateral direction by use of the fixed light-guiding member 5, and a second position where a light path is formed between a different pair of the optical fibers in the lateral direction by use of the movable light-guiding member 6.

In this embodiment, as shown in FIG. 11A, the optical fibers (2a to 2d) are arranged in a 1×4 linear array such that their optical axes are parallel to each other on the same horizontal plane. In addition, as shown in FIG. 11B, the lens supporting member 10 is composed of a lower block 13 having four V-grooves 12 for receiving the lenses in its top surface, and an upper block 14, which is pressed against the top surface of the lower block to support the lenses in the V-grooves. Thus, since the lenses are integrally supported by the lens supporting member 10, it is possible to easily assemble the optical switch.

As shown in FIGS. 12A and 12B, a pair of fixed prisms each having a triangular prism shape is used as the fixed light-guiding member 5 of the present embodiment. As described later, at the first position, one of the fixed prisms forms the light path between the lenses (4a, 4b), and the other fixed prism forms the light path between the lenses (4c, 4d). Specifically, each of the fixed prisms is formed with top and bottom isosceles-triangle surfaces, and a pair of sides having an intersection angle of 90 degrees. Reflecting surfaces (50A and 51A, 50B and 51B) are provided by these sides. The fixed prism 5 is disposed such that the remaining side other than the pair of sides used as the reflecting surfaces faces the lenses (4a to 4d) through a space for allowing the movable prism 6 to move in and out.

On the other hand, as the movable light-guiding member 6, as shown in FIGS. 13A and 13B, a movable prism having a trapezoid cross section is used. As described later, at the second position, this movable prism 6 simultaneously forms light paths between the lenses 4a and 4d and between the lenses 4b and 4c. Specifically, this movable prism is formed with a pair of trapezoidal side surfaces 60A, top surface 61A including an upper side of the trapezoid, bottom surface 62A including a lower side of the trapezoid, and a pair of inclined surfaces (63A, 64A) extending between the top and bottom surfaces. An intersection angle between the inclined surfaces is right angle. The light paths formed at the second position are simultaneously provided by these inclined surfaces as reflecting surfaces. The movable prism is disposed such that the bottom surface 62A faces the lenses (4a to 4d) at the second position. In this embodiment, since the prism having the trapezoidal cross section is used, a downsizing of the movable prism can be achieved. Alternatively, a prism having a cross section of a right-angled isosceles triangle may be used as the movable prism. In this case, the reflecting surfaces (63A, 64A) intersect at right angle to define a right-angle corner portion.

The actuator 7 is not restricted on the assumption that the movable prism 6 can be moved upward and downward. In this embodiment, as shown by the solid line and the dotted line in FIG. 10B, by moving an arm 70 having the movable prism secured to its one end, the movable prism 6 is allowed to move in and out of the space between the fixed prism 5 and the lenses (4a to 4d). In the figure, the numeral 72 designates terminals used to supply electric current to a coil of the actuator. When the lens supporting member 10, fixed prism 5, and the actuator 7 are previously mounted on a substrate, and then the substrate is installed in the housing 1, it is possible to efficiently and easily assemble the optical switch.

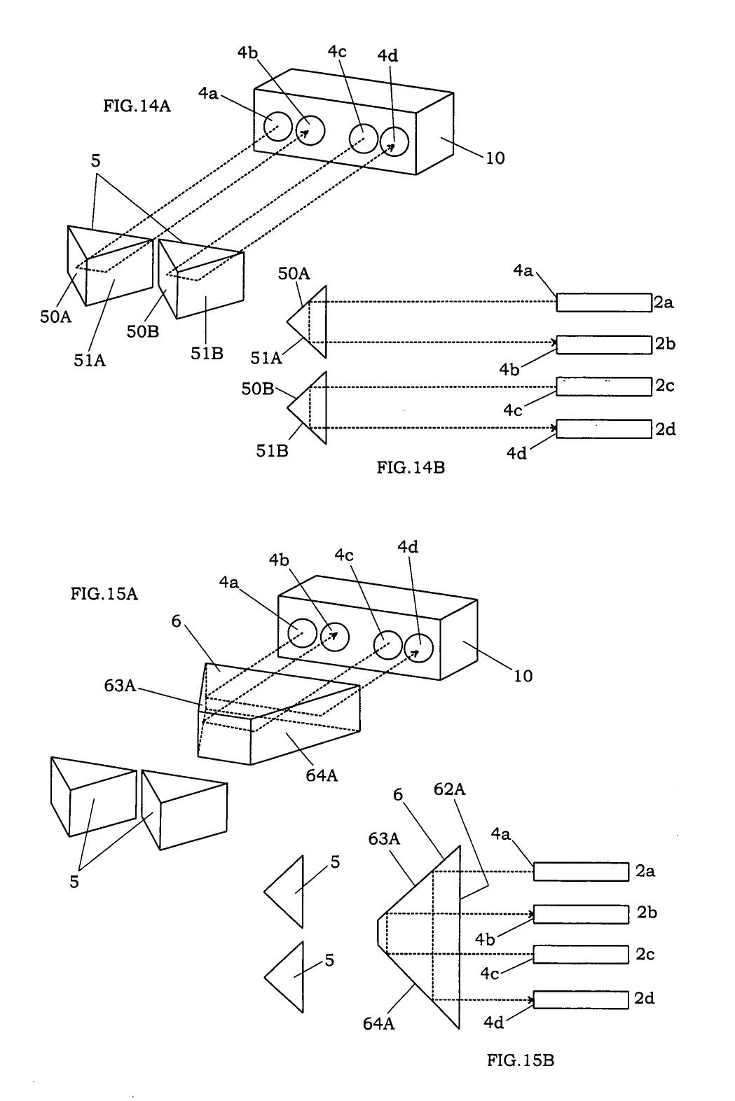

Next, operations of the optical switch are explained. At the first position where the movable prism 6 secured to the one end of the arm 70 removed from the space between the lenses (4a to 4d) and the fixed prisms 5 by the actuator 7, the lenses (4a to 4d) are optically coupled with the pair of fixed prisms 5. In this embodiment, as shown in FIGS. 14A and 14B, the light provided from the optical fiber 2a through the lens 4a travels toward the lens 4b through the pair of reflecting surfaces (50A, 51A) of one of the fixed prisms. As a result, the light path is formed between adjacent lenses 4a, 4b. Similarly, the light provided from the optical fiber 2c through the lens 4c travels toward the lens 4d through the pair of reflecting surfaces (50B, 51B) of the other fixed prism 5. As a result, the light path is formed between adjacent lenses 4c, 4d. Thus, the light paths are formed between adjacent lenses (4a and 4b, 4c and 4d) arranged in the horizontal direction at the first position.

In the second position where the movable prism 6 is inserted into the space between the fixed prisms 5 and the lenses (4a to 4d) by the actuator 7, the movable prism 6 is optically coupled to the lenses (4a to 4d). In the present embodiment, as shown in FIGS. 15A and 15B, the light provided from the optical fiber 2a through the lens 4a travels toward the lens 4d through the pair of reflecting surfaces (63A, 64A) of the movable prism 6. As a result, the light path is formed between the lenses 4a, 4d. In addition, the light provided from the optical fiber 2c through the lens 4c travels toward the lens 4b through the pair of reflecting surfaces (64A, 63A) of the movable prism 6. As a result, the light path is formed between the lenses 4b, 4c. Thus, the light paths are formed at the second position between different pairs (4a and 4d, 4b and 4c) of the lenses from the pairs of the lenses at the first position, which are spaced from each other in the horizontal direction.

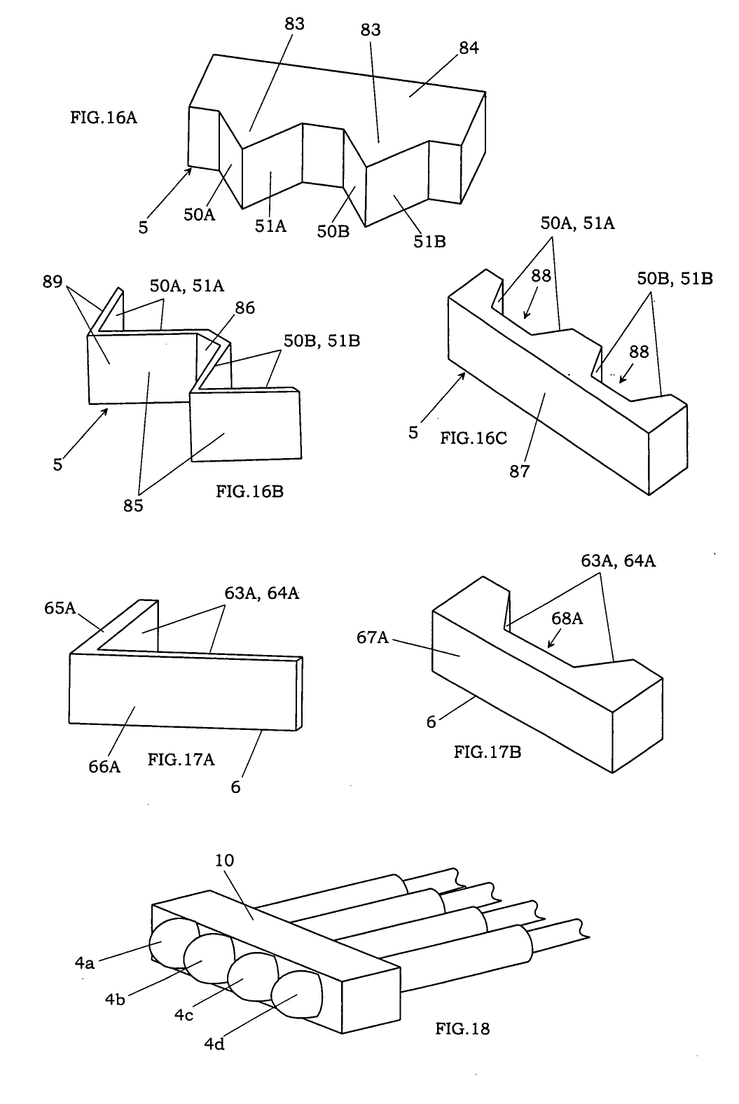

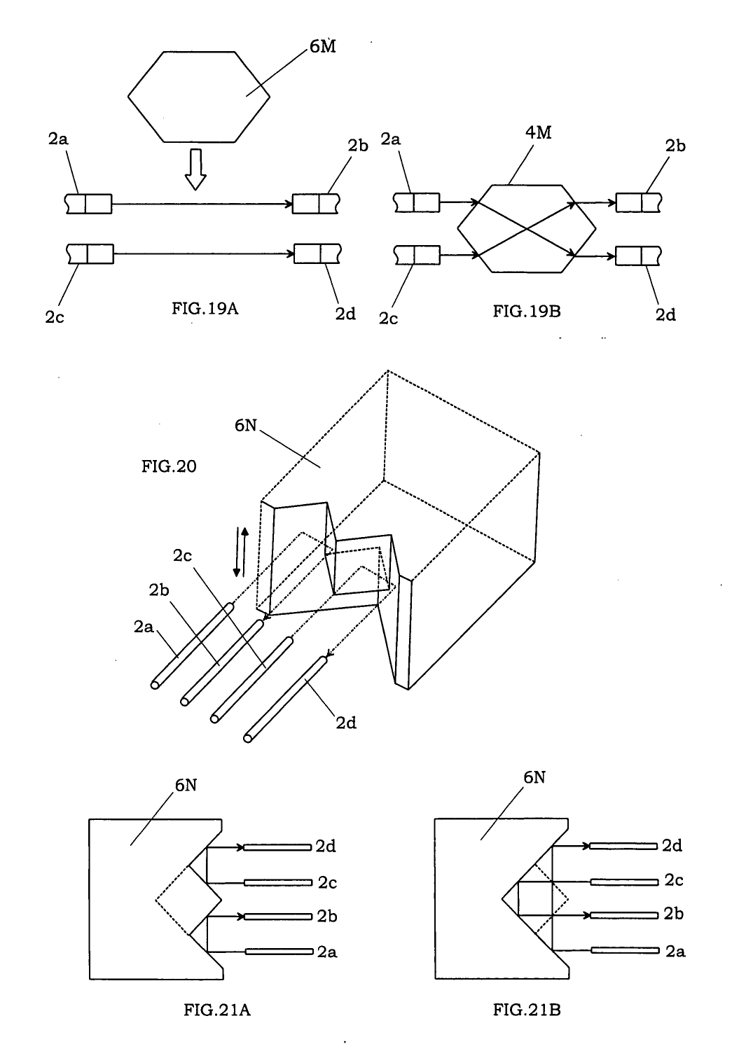

In the above embodiment, the pair of fixed prisms 5 were used. Alternatively, as shown in FIG. 16A, a single fixed prism may be used, which is formed with a rectangular coupling member 84 of a translucent material and a pair of triangular prisms 82 integrally bonded to a side of the coupling member. In this case, the same effect as the above is obtained, and also the optical switch can be efficiently assembled due to a reduction in the total number of parts.

As another preferred embodiments of the fixed light-guiding member 5 of the present optical switch, a single fixed light-guiding member 5 shown in FIG. 16B may be used, which comprises a pair of thin L-shaped members 85 and a coupling member 86 interposed therebetween. In this case, each of the thin L-shaped members 85 is provided with a pair of plates 89 connected to each other such that an intersection angle therebetween is right angle and reflecting surfaces (50A and 51A, 50B and 51B) formed as the reflecting portions on the plates by, for example, a mirror coating. In addition, it is preferred to use a single reflection coating member, which is formed with a rectangular solid body 87, a pair of concaves 88 formed in the body, and reflecting surfaces (50A and 51A, 50B and 51B) formed on a pair of inclined surfaces in each of the concaves 88 by, for example, the mirror coating.

As another preferred embodiments of the movable light-guiding member 6 of the present optical switch, a thin L-shaped member shown in FIG. 17A may be used, which comprises a pair of plates (65A, 66A) connected to each other such that an intersection angle therebetween is right angle, and reflecting surfaces (63A, 64A) formed as the reflecting portions on the plates. Alternatively, as shown in FIG. 17B, a reflection coating member may be used, which is formed with a rectangular solid body 67A having a concave 68A and reflecting surfaces (63A, 64A) formed on a pair of inclined surfaces in the concave by, for example, the mirror coating.

As a modification of the present embodiment, GRIN lenses may be disposed in the V-grooves 12 of the lens supporting member 10 in place of the molded lenses. In addition, as shown in FIG. 18, a lens block obtained by embedding an alignment of hemispherical lenses or spherical lenses in the lens supporting member 10 may be used in place of the lens supporting member 10 comprised of the upper and lower blocks (13, 14).

To enhance the understanding of the invention, the light-path switching mechanism in the linear (1×4) arrangement of the four optical fibers was explained in this embodiment. However, the number of optical fibers used in the optical switch is not restricted to four. For example, a size of the movable prism, or the number of the fixed prism can be increased depending on the number of optical fibers to be switched.

### INDUSTRIAL APPLICABILITY

Thus, the optical switch of the present invention has advantages of a high degree of freedom of design of the light path, compact size and excellent cost performance. Therefore, it is expected to be utilized in various applications such as switching light signals in optical networks and switching light-energy transmission paths in laser manufacturing.

1.-20. (canceled)

21. An optical switch comprising:
four lenses;
a lens supporting member configured to support said lenses;
a fixed light-guiding member optically coupled to said lenses; and
a movable light-guiding member comprising a pair of blocks each having two reflecting portions that are in an orthogonal relation to each other, and a coupling member for coupling between the pair of blocks such that said reflecting portions of one of said blocks are spaced away from said reflecting portions of the other block by a space,
wherein said movable light-guiding member is movable relative to said lenses between a first position where light paths are formed between two lenses of said four lenses and the remaining two lenses by use of said fixed light-guiding member and a second position where light paths are formed between another two lenses of said four lenses and the remaining two lenses by use of said movable light-guiding member.

22. The optical switch as set forth in claim 21, wherein said fixed light-guiding member has a first reflecting portion for reflecting a light emitted from each of said two lenses in the first position, and a second reflecting portion for reflecting the lights reflected by the first reflecting portion toward the remaining two lenses, respectively.

23. The optical switch as set forth in claim 22, wherein said fixed light-guiding member has a body made of a translucent material, and the first and second reflecting portions formed on a pair of surfaces of said body.

24. The optical switch as set forth in claim 22, wherein said fixed light-guiding member is formed by a trapezoidal prism, and the first and second reflecting portions are provided by a pair of inclined surfaces of said trapezoidal prism, which are in an orthogonal relation to each other.

25. The optical switch as set forth in claim 22, wherein an angle between said first reflecting portion and said second reflecting portion of said fixed light-guiding member is a right angle.

26. The optical switch as set forth in claim 22, wherein said movable light-guiding member is disposed such that an axis extending in parallel with said first and second reflecting portions of said fixed light-guiding member is in an orthogonal relation to the axis extending in parallel with said two reflecting portions of said movable light-guiding member.

27. The optical switch as set forth in claim 21, wherein each of said blocks of said movable light-guiding member is formed by a trapezoidal prism.

28. The optical switch as set forth in claim 21, further comprising an actuator for moving an arm having said movable light-guiding member secured at its one end such that said movable light-guiding member is allowed to move in and out of a space between said fixed light-guiding member and said lenses.

29. The optical switch as set forth in claim 21, comprises a ferrule for optical fiber connector disposed at a side of each of said four lenses, at the opposite side of which said fixed light-guiding member is disposed.

30. The optical switch as set forth in claim 21, wherein said four lenses are integrally formed with said lens supporting member.

31. The optical switch as set forth in claim 21, wherein said lens supporting member supports said four lenses such that their optical axes are parallel to each other in horizontal and vertical directions.

32. The optical switch as set forth in claim 31, wherein said lens supporting member has a tubular structure, in which said four lenses are accommodated.

33. The optical switch as set forth in claim 21, wherein said movable light-guiding member comprises a thin L-shaped member comprising a pair of plates connected such that an intersection angle therebetween is a right angle, a pair of reflecting surfaces formed as said reflecting portions on surfaces of said plates, and a pair of notches formed at predetermined positions of said plates and used to form the light paths in the first position.

34. The optical switch as set forth in claim 21, wherein said four lens are composed of first, second, third and fourth lenses disposed such that their optical axes are parallel to each other in horizontal and vertical directions,
said fixed light-guiding member comprises a first reflecting portion for reflecting a light emitted from the first lens, second reflecting portion for reflecting a light emitted from the third lens, third reflecting portion for reflecting the light reflected by the first reflecting portion toward the second lens, and a fourth reflecting portion for reflecting the light reflected by the second reflecting portion toward the fourth lens at the first position, and
said movable light-guiding member comprises a fifth reflecting portion for reflecting a light emitted from the first lens, sixth reflecting portion for reflecting the light reflected by the fifth reflecting portion toward the fourth lens, seventh reflecting portion spaced away from the sixth reflecting portion by a space to reflect a light emitted from the third lens, and an eighth reflecting portion spaced from the fifth reflecting portion by a space to reflect the light reflected by seventh reflecting portion toward the second lens at the second position,
wherein at the first position, the light path between the first and second lenses is formed through the space between the fifth and eighth reflecting portions, and the light path between the third and fourth lenses is formed through the space between the sixth and seventh reflecting portions.

35. The optical switch as set forth in claim 34, wherein angles between the first reflecting portion and the third reflecting portion, between the second reflecting portion and the fourth reflecting portion, between the fifth reflecting portion and the sixth reflecting portion, and between the seventh reflecting portion and the eighth reflecting portion are right angles, respectively.

36. The optical switch as set forth in claim 34, wherein said fixed light-guiding member comprises a single reflecting surface providing the first reflecting portion and the fourth reflecting portion, and a single reflecting surface providing the second reflecting portion and the third reflecting portion, and wherein an angle between said reflecting surfaces is a right angle.

37. An optical switch comprising:
four lenses disposed such that their optical axes are parallel to each other in a same plane;
a lens supporting member configured to support said lenses;
a fixed light-guiding member optically coupled to said lenses;
a movable light-guiding member, which is movable relative to said lenses between a first position where light paths are formed between two lenses of said four lenses and the remaining two lenses by use of said fixed light-guiding member and a second position where light paths are formed between another two lenses of said four lenses and the remaining two lenses by use of said movable light-guiding member; and.
an actuator for moving an arm having said movable light-guiding member secured at its one end such that said movable light-guiding member is allowed to move in and out of a space between fixed light-guiding member and said lenses;
wherein said fixed light-guiding member comprises two pairs of reflecting surfaces that are in an orthogonal relation to each other, said movable light-guiding member has a pair of reflecting surfaces that are in an orthogonal relation to each other, and the light paths are simultaneously formed in the second position between said another two lenses and the remaining two lenses through the pair of reflecting surfaces of said movable light-guiding member.
